(19) United States
(12) Patent Application Publication
(10) Pub. No.: US 2022/0045548 A1
(43) Pub. Date: Feb. 10, 2022

(54) INFORMATION PROCESSING DEVICE, INFORMATION PROCESSING SYSTEM, INFORMATION PROCESSING METHOD, AND POWER SUPPLY EQUIPMENT

(71) Applicant: Toyota Jidosha Kabushiki Kaisha, Toyota-shi Aichi-ken (JP)

(72) Inventors: Shin Sakurada, Toyota-shi Aichi-ken (JP); Yasuhiro Baba, Kamo-gun Gifu-ken (JP); Shuichi Sawada, Nagoya-shi Aichi-ken (JP); Shintaro Matsutani, Kariya-shi Aichi-ken (JP); Yurika Tanaka, Yokosuka-shi Kanagawa-ken (JP); Ryosuke Kobayashi, Nagakute-shi Aichi-ken (JP); Genshi Kuno, Kasugai-shi Aichi-ken (JP); Tomoya Makino, Kariya-shi Aichi-ken (JP)

(73) Assignee: Toyota Jidosha Kabushiki Kaisha, Toyota-shi Aichi-ken (JP)

(21) Appl. No.: 17/395,009

(22) Filed: Aug. 5, 2021

(30) Foreign Application Priority Data
Aug. 7, 2020 (JP) 2020-135385

(51) Int. Cl. H02J 13/00; H02J 50/00; G06Q 30/04; G06Q 50/06

(52) U.S. Cl. CPC H02J 13/00002; G06Q 50/06; G06Q 30/04; H02J 50/00

(57) ABSTRACT

An information processing device includes a control unit configured to generate power supply permission information that is information permitting power to be supplied to a device electromagnetically connected to power supply equipment, and output the power supply permission information to the power supply equipment.

### CROSS-REFERENCE TO RELATED APPLICATION

This application claims priority to Japanese Patent Application No. 2020-135385 filed on Aug. 7, 2020, incorporated herein by reference in its entirety.

### BACKGROUND

### 1. Technical Field

The present disclosure relates to an information processing device, an information processing system, an information processing method, and power supply equipment.

### 2. Description of Related Art

A system for supplying power from a user authentication outlet is known in the art (see, e.g., Japanese Unexamined Patent Application Publication No. 2019-71780 (JP 2019-71780 A).

### SUMMARY

The user authentication outlet needs to have an authentication function in order to authenticate individual devices and supply power to the devices. The authentication function can complicate the configuration of the devices. It is therefore desired to implement simple, easy billing according to the amount of power supplied to a device.

The present disclosure provides an information processing device, an information processing system, an information processing method, and power supply equipment that can implement simple, easy billing according to the amount of power supplied to a device.

A first aspect of the present disclosure relates to an information processing device. The information processing device includes a control unit configured to generate power supply permission information that is information permitting power to be supplied to a device electromagnetically connected to power supply equipment, and output the power supply permission information to the power supply equipment.

In the first aspect, the control unit may be configured to acquire device information including information identifying the device from the power supply equipment and generate the power supply permission information based on the device information.

In the above aspect, the control unit may be configured to acquire, from the power supply equipment, user information that is information about a user of the device, and generate the power supply permission information based on the user information.

In the above aspect, the control unit may be configured to acquire power supply request information that is information requesting power supply to the device, and generate the power supply permission information based on the power supply request information.

In the above aspect, the control unit may be configured to generate the power supply permission information when the control unit acquires the power supply request information within a predetermined time.

In the above aspect, the control unit may be configured to generate and output power supply prohibition information that is information prohibiting power from being supplied to the device when the control unit does not acquire the power supply request information within the predetermined time.

In the above aspect, the control unit may be configured to acquire, as the power supply request information, information that a user of the device accepts that power supply from the power supply equipment is for a fee.

In the above aspect, the control unit may be configured to acquire, as the power supply request information, billing information on an electricity charge according to an amount of power supplied from the power supply equipment to the device.

In the above aspect, the control unit may be configured to acquire the amount of power supplied from the power supply equipment to the device, calculate the electricity charge based on the amount of power supplied, and bill for the electricity charge based on the billing information.

In the above aspect, the control unit may be configured to acquire, as the billing information, a balance that is able to be applied to the electricity charge, and when the electricity charge exceeds the balance, generate and output power supply stop information that is information for stopping the power supply to the device.

A second aspect of the present disclosure relates to an information processing system. The information processing system includes the information processing device according to the above aspect and the power supply equipment.

A third aspect of the present disclosure relates to an information processing method. The information processing method includes: generating power supply permission information that is information permitting power to be supplied to a device electromagnetically connected to power supply equipment, and outputting the power supply permission information to the power supply equipment.

In the third aspect, the information processing method may further include: acquiring device information identifying the device from the power supply equipment; and generating the power supply permission information based on the device information.

In the above aspect, the information processing method may further include: acquiring, from the power supply equipment, user information that is information about a user of the device; and generating the power supply permission information based on the user information.

In the above aspect, the information processing method may further include: acquiring power supply request information that is information requesting power supply to the device; and generating the power supply permission information based on the power supply request information.

In the above aspect, the information processing method may further include: generating the power supply permission information when the power supply request information is acquired within a predetermined time; and generating and outputting power supply prohibition information that is information prohibiting power from being supplied to the device when the power supply request information is not acquired within the predetermined time.

In the above aspect, the information processing method may further include acquiring, as the power supply request information, information that a user of the device accepts that power supply from the power supply equipment is for a fee.

In the above aspect, the information processing method may further include acquiring, as the power supply request information, billing information on an electricity charge according to an amount of power supplied from the power supply equipment to the device.

In the above aspect, the information processing method may further include: acquiring the amount of power supplied from the power supply equipment to the device; calculating the electricity charge based on the amount of power supplied; and billing for the electricity charge based on the billing information.

A fourth aspect of the present disclosure relates to power supply equipment. The power supply equipment includes: a power supply unit configured to supply power to a device electromagnetically connected to the power supply unit; and a power supply control unit configured to control the power supply unit based on information acquired from an information processing device. The power supply control unit is configured to control the power supply unit to supply power to the device when the power supply control unit acquires, from the information processing device, power supply permission information that is information permitting power to be supplied to the device.

According to each aspect of the present disclosure, simple, easy billing according to the amount of power supplied to the device can be implemented.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a configuration example of an information processing system;

FIG. 2 is a flowchart of an example of a process that is performed by an information processing device; and

FIG. 3 is a flowchart of an example of a process that is performed by power supply equipment.

### DETAILED DESCRIPTION OF EMBODIMENTS

Overview of Information Processing System 1

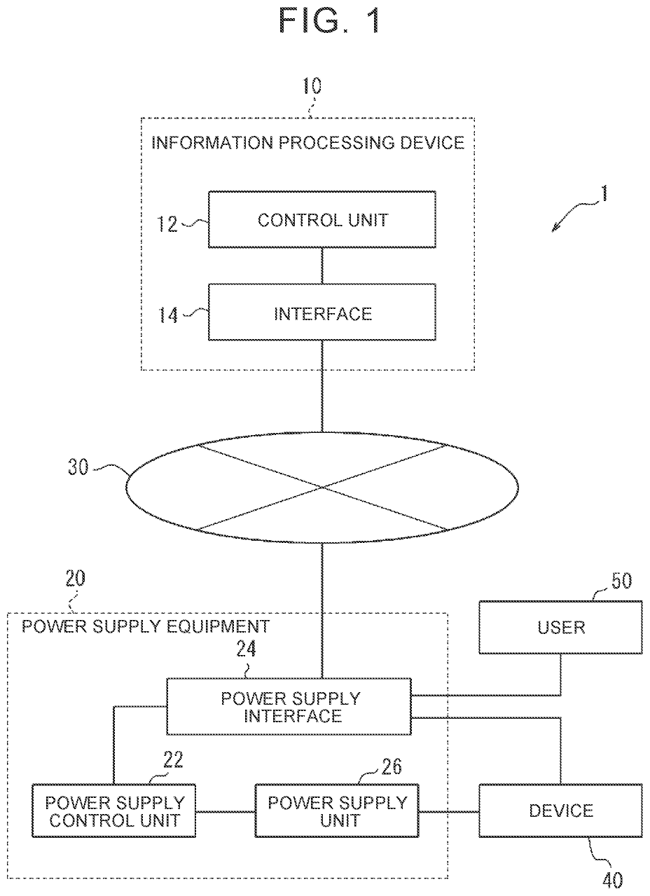

As shown in FIG. 1, an information processing system 1 according to an embodiment includes an information processing device 10 and power supply equipment 20. The power supply equipment 20 is configured so that a device 40 can be electromagnetically connected to the power supply equipment 20. The device 40 may be various electrical devices, electronic devices, etc. The power supply equipment 20 supplies power to the device 40 electromagnetically connected to the power supply equipment 20, based on an instruction from the information processing device 10. The information processing device 10 causes the power supply equipment 20 to supply power to the device 40, and bills a user 50 of the device 40 for an electricity charge. That is, the information processing system 1 provides to the user 50 a service of supplying power to the device 40 for a charge.

The information processing device 10 acquires information from the power supply equipment 20 and also outputs information to the power supply equipment 20. The power supply equipment 20 acquires information from the information processing device 10 and also outputs information to the information processing device 10. The information processing device 10 and the power supply equipment 20 may be configured to communicate with each other. The information processing device 10 and the power supply equipment 20 may be communicably connected via a network 30. The information processing device 10 and the power supply equipment 20 may be communicably connected without via the network 30.

The number of information processing devices 10 is not limited to one, and may be two or more. The number of pieces of power supply equipment 20 is not limited to one, and may be two or more.

Specific Configuration Example of Information Processing System 1

A specific configuration example of the information processing system 1 will be described.

Information Processing Device 10

The information processing device 10 may include one or more server devices capable of communicating with each other. The information processing device 10 includes a control unit 12 and an interface 14. The control unit 12 outputs information to the power supply equipment 20 through the interface 14 and also acquires information from the power supply equipment 20 through the interface 14. Based on the information acquired from the power supply equipment 20, the control unit 12 generates information permitting power to be supplied to the device 40 electromagnetically connected to the power supply equipment 20, and outputs the generated information to the power supply equipment 20. The information permitting the power supply equipment 20 to supply power is also referred to as power supply permission information.

The control unit 12 may include one or more processors. In the present embodiment, the “processor” is, but is not limited to, a general-purpose processor, a dedicated processor specialized for particular processing, etc. The control unit 12 may include one or more dedicated circuits. The dedicated circuit may include, e.g., a field-programmable gate array (FPGA) or an application-specific integrated circuit (ASIC). The control unit 12 may include the dedicated circuit(s) instead of the processor(s) or may include the dedicated circuit(s) together with the processor(s).

The information processing device 10 may further include a storage unit. The storage unit may include an electromagnetic storage medium such as a magnetic disk. The storage unit may include, e.g., a semiconductor memory, a magnetic memory, an optical memory, etc. The storage device included in the storage unit is not limited to these examples, and the storage unit may include various other storage devices. The storage unit may function as, e.g., a main storage device, an auxiliary storage device, or a cache memory. The storage unit may include a non-transitory computer-readable medium. The storage unit stores desired information to be used for the operation of the information processing device 10. For example, the storage unit may store a system program, an application program, etc. The storage unit may be configured integrally with the control unit 12, or may be configured as a separate unit from the control unit 12.

The interface 14 may include a connector, port, etc. to which a wire for outputting and acquiring information based on various data communication standards such as RS232C or RS485 can be connected. The interface 14 may include a communication device. The communication device may communicate with the power supply equipment 20 via the network 30, or may communicate with the power supply equipment 20 without via the network 30. The communication device may include, e.g., a communication module compatible with mobile communication standards such as the fourth generation (4G) and the fifth generation (5G). The communication device may include a communication module compatible with communication standards such as a local area network (LAN). The communication module included in the communication device is not limited to these, and the communication device may include various other modules.

Power Supply Equipment 20

The power supply equipment 20 includes a power supply control unit 22, a power supply interface 24, and a power supply unit 26. The power supply control unit 22 may include a configuration that is the same as, or similar to, that of the control unit 12 of the information processing device 10. The power supply interface 24 may include a configuration that is the same as, or similar to, that of the interface 14 of the information processing device 10.

The power supply unit 26 is configured to be electromagnetically connected to the device 40. The electromagnetic connection may include contact between electrodes of the power supply unit 26 and electrodes of the device 40. Specifically, the power supply unit 26 may include an outlet into which a power plug for allowing power to be supplied to the device 40 is inserted. The power supply unit 26 may include a port into which a connector for allowing power to be supplied to the device 40 is inserted. The electromagnetic connection may include electromagnetic coupling between an antenna of the power supply unit 26 and an antenna of the device 40. Specifically, the power supply unit 26 may include an antenna that supplies power to the device 40 in a non-contact manner.

The power supply equipment 20 is configured to detect whether the device 40 is electromagnetically connected to the power supply unit 26. For example, the power supply unit 26 may include a sensor configured to detect contact of a terminal of the device 40 with the power supply unit 26. In this case, the power supply control unit 22 may acquire information for detecting contact of the terminal of the device 40 with the power supply unit 26 from the sensor. For example, the power supply control unit 22 may detect the impedance of the power supply unit 26. The power supply control unit 22 may detect a change in impedance caused by contact of the terminal of the device 40 with the power supply unit 26. The power supply control unit 22 may detect a change in impedance caused by electromagnetic coupling of the power supply unit 26 to the antenna of the device 40.

When the device 40 is electromagnetically connected to the power supply unit 26, the power supply control unit 22 may output information indicating that the device 40 is electromagnetically connected to the power supply unit 26 from the power supply interface 24 to the information processing device 10. The information indicating that the device 40 is electromagnetically connected to the power supply unit 26 is also referred to as connection information. The power supply control unit 22 may output information requesting power supply from the power supply unit 26 to the device 40 from the power supply interface 24 to the information processing device 10. The information requesting power supply from the power supply unit 26 to the device 40 is also referred to as power supply request information.

The power supply unit 26 can control whether to start or stop power supply to the device 40 electromagnetically connected to the power supply unit 26. The power supply unit 26 may include an open and close switch such as a relay and may control power supply to the device 40 by switching the state of the open and close switch based on the control information. For example, the power supply unit 26 can start power supply to the device 40 by switching the open and close switch to a closed state, and can stop power supply to the device 40 by switching the open and close switch to an open state.

The power supply control unit 22 controls the power supply unit 26. Specifically, the power supply control unit 22 generates control information for controlling whether the power supply unit 26 should start or stop power supply to the device 40, and outputs the control information to the power supply unit 26. The power supply unit 26 starts or stops power supply to the device 40 based on the control information acquired from the power supply control unit 22.

The power supply control unit 22 acquires information such as power supply permission information from the information processing device 10 by the power supply interface 24. When the power supply control unit 22 acquires the power supply permission information from the information processing device 10, the power supply control unit 22 outputs the control information for starting power supply from the power supply unit 26 to the device 40 to the power supply unit 26.

The power supply control unit 22 may notify the user 50 of the information acquired from the information processing device 10 by the power supply interface 24. For example, the power supply interface 24 may include a display device configured to display information acquired from the information processing device 10 by characters, figures, etc. The display device may include, e.g., various displays such as a liquid crystal display, an organic electro-luminescence (EL) display, or an inorganic EL display. The display device may include a light emitting device such as a light emission diode (LED). The power supply interface 24 may include a voice output device configured to output information acquired from the information processing device 10 by voice, such as a speaker. The output device included in the power supply interface 24 is not limited to these, and the power supply interface 24 may include various other output devices.

The power supply control unit 22 may acquire information about the device 40 electromagnetically connected to the power supply unit 26 from the power supply interface 24. The information about the device 40 electromagnetically connected to the power supply unit 26 is also referred to as device information. The power supply control unit 22 outputs the device information from the power supply interface 24 to the information processing device 10. The power supply control unit 22 may output the device information to the information processing device 10 as a part of the connection information or a part of the power supply request information.

The device information may include information identifying the device 40. The information identifying the device 40 may include, e.g., the model number or serial number, Internet Protocol (IP) address, etc. of the device 40. The device information may include information for processing billing to the device 40. For example, the device information may include credit card information or balance information of electronic money linked to the device 40. The information for processing billing to the device 40 is also referred to as billing information.

The power supply control unit 22 may acquire the device information from the device 40 by the power supply interface 24. In this case, the power supply interface 24 may be configured to communicate with the device 40.

The power supply control unit 22 may acquire information about the user 50 who has the device 40 by the power supply interface 24. The information about the user 50 who has the device 40 is also referred to as user information. The power supply control unit 22 outputs the user information to the information processing device 10 through the power supply interface 24. The power supply control unit 22 may output the user information to the information processing device 10 as a part of the connection information or a part of the power supply request information.

The power supply control unit 22 may acquire biological information of the user 50 as the user information. The power supply control unit 22 may acquire the biological information of the user 50 by the power supply interface 24. The power supply interface 24 may include a camera, a sensor, etc. configured to acquire the biological information of the user 50.

The power supply control unit 22 may acquire identification information of the user 50 as the user information. The power supply control unit 22 may acquire the identification information of the user 50 by the power supply interface 24. The identification information of the user 50 may include information described in a certificate issued by a public institution, such as a driver's license or a health insurance card, or may include electronic information recorded on an integrated circuit (IC) chip embedded in the driver's license etc. The power supply interface 24 may include a camera, an IC chip reader, etc. configured to acquire the identification information of the user 50.

The power supply control unit 22 may accept an input from the user 50 as the user information. In this case, the power supply interface 24 may include an input device such as a touch panel or a physical key. The power supply control unit 22 may allow the user 50 to input the billing information for processing billing for power supply from the power supply equipment 20 to the device 40, such as credit card information.

Specific Operation Example of Information Processing System 1

A specific operation example of the information processing system 1 will be described.

The power supply control unit 22 of the power supply equipment 20 confirms that the device 40 is electromagnetically connected to the power supply unit 26. The power supply control unit 22 may output the connection information indicating that the device 40 is electromagnetically connected to the power supply unit 26 to the information processing device 10. The power supply control unit 22 may output the device information or the user information to the information processing device 10 as the connection information.

The control unit 12 of the information processing device 10 acquires the connection information from the power supply equipment 20. When the control unit 12 acquires the connection information, the control unit 12 outputs information confirming whether the device 40 requests the use of the power supply equipment 20. In other words, the control unit 12 outputs information confirming whether the device 40 requests power supply from the power supply equipment 20. The information confirming whether the device 40 requests the use of the power supply equipment 20 is also referred to as use confirmation information.

The power supply control unit 22 may notify the user 50 of the use confirmation information acquired from the information processing device 10 by the power supply interface 24. For example, the power supply interface 24 may cause the user 50 to recognize the use confirmation information by displaying the use confirmation information by characters, figures, etc. or by outputting the use confirmation information by voice. The power supply control unit 22 may output the use confirmation information from the power supply interface 24 to the device 40 to cause the device 40 to notify the user 50 of the use confirmation information.

The power supply control unit 22 acquires a response to the use confirmation information from the device 40 itself or the user 50 who has the device 40. For example, as the use confirmation information, the power supply control unit 22 may notify the user 50 of information confirming whether the user 50 accepts that power supply from the power supply equipment 20 to the device 40 is for a fee from the power supply interface 24. The power supply control unit 22 may notify the user 50 of the information and accept an input confirming whether the user 50 accepts that power supply is for a fee from the user 50 via the power supply interface 24. The power supply control unit 22 may notify the user 50 of the information and accept an input of the information for processing billing for power supply to the device 40 from the device 40 or the user 50 by the power supply interface 24.

When the power supply control unit 22 acquires, as a response to the use confirmation information, the information that the user 50 accepts that power supply from the power supply equipment 20 to the device 40 is for a fee or the information for processing billing for power supply to the device 40, the power supply control unit 22 determines that power supply to the device 40 is requested. The power supply control unit 22 generates information requesting power supply from the power supply unit 26 to the device 40, that is, the power supply request information. The power supply control unit 22 outputs the power supply request information from the power supply interface 24 to the information processing device 10 as a response to the use confirmation information. The power supply request information may include the user information or the device information. The power supply request information may be output from the device 40 itself to the information processing device 10. The power supply request information may be input to the device 40 by the user 50 and output from the device 40 to the information processing device 10. The power supply request information may be input to the power supply interface 24 or the device 40 by the user 50.

The control unit 12 acquires the power supply request information from the power supply equipment 20. The control unit 12 determines whether to permit power supply from the power supply equipment 20 to the device 40, based on the power supply request information. When the control unit 12 acquires the device information or the user information as the connection information, the control unit 12 may determine whether to permit power supply from the power supply equipment 20 to the device 40, based on the device information or the user information. For example, when the control unit 12 can determine that billing for power supply to the device 40 can be processed, the control unit 12 may permit power supply from the power supply equipment 20 to the device 40. The control unit 12 may estimate the amount of power that is supplied to the device 40. When the amount of power that is supplied to the device 40 is equal to or less than a predetermined value, the control unit 12 may permit power supply from the power supply equipment 20 to the device 40.

When the control unit 12 determines that power supply from the power supply equipment 20 to the device 40 is permitted, the control unit 12 generates the power supply permission information and outputs the power supply permission information to the power supply equipment 20. The power supply control unit 22 acquires the power supply permission information and causes the power supply unit 26 to start power supply to the device 40 based on the power supply permission information. The power supply control unit 22 may acquire information about the state of charge (SOC) from the device 40 and may complete power supply to the device 40 when the SOC of the device 40 becomes equal to or larger than a predetermined value. The power supply control unit 22 may calculate the amount of power supplied to the device 40 and may complete power supply to the device 40 when the amount of power supplied to the device 40 becomes equal to or larger than a predetermined value.

When the power supply control unit 22 completes power supply to the device 40, the power supply control unit 22 calculates the amount of power supplied to the device 40 and outputs the calculation result to the information processing device 10. The control unit 12 acquires from the power supply equipment 20 the amount of power supplied to the device 40, calculates an electricity charge based on the amount of power supplied to the device 40, and charges for the power supplied to the device 40. The control unit 12 may pay for the electricity charge based on the billing information acquired from the power supply equipment 20.

As described above, the information processing system 1 according to the present embodiment permits power supply from the power supply equipment 20 to the device 40 based on the power supply request information acquired from the power supply equipment 20. The information processing system 1 can thus charge for the power supplied to the device 40 even when the power supply equipment 20 does not have a configuration for authenticating the device 40. As a result, the information processing system 1 can implement simple, easy billing according to the amount of power supplied to the device 40.

Example of Flowchart of Information Processing Method

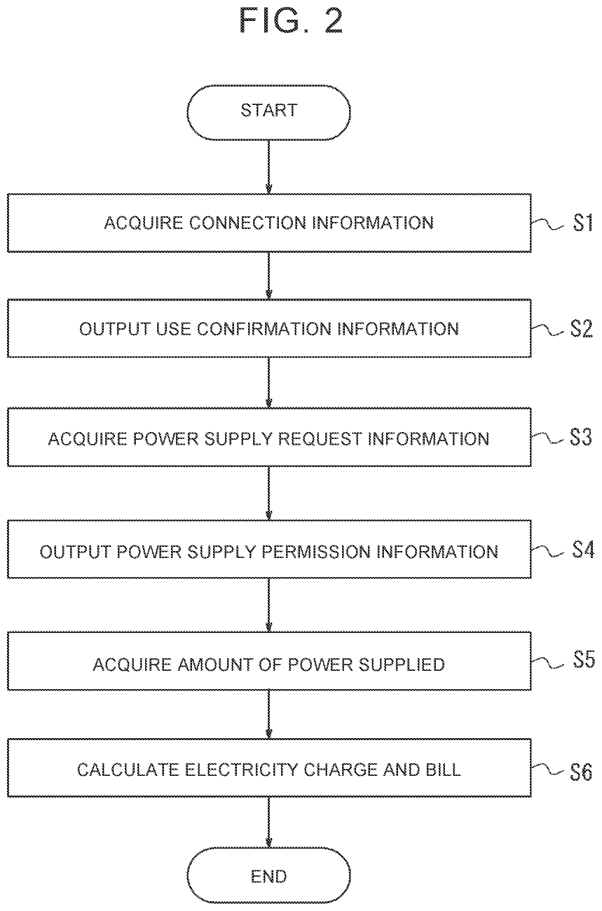

The control unit 12 of the information processing device 10 included in the information processing system 1 may perform an information processing method including a process shown by a flowchart of FIG. 2. The information processing method may be implemented as an information processing program that is executed by a processor such as the control unit 12. The information processing program may be stored in a non-transitory computer-readable medium.

The control unit 12 acquires the connection information from the power supply equipment 20 (step S1). The connection information is generated and output by the power supply equipment 20 when the device 40 is connected to the power supply equipment 20.

The control unit 12 outputs the use confirmation information to the power supply equipment 20 to which the device 40 is connected (step S2).

The control unit 12 acquires the power supply request information from the power supply equipment 20 to which the device 40 is connected (step S3). The power supply request information may include the device information of the device 40 connected to the power supply equipment 20 or the user information of the user 50 of the device 40.

When the control unit 12 determines based on the power supply request information that power supply from the power supply equipment 20 to the device 40 is permitted, the control unit 12 generates the power supply permission information and outputs the power supply permission information to the power supply equipment 20 (step S4).

The control unit 12 acquires the amount of power supplied from the power supply equipment 20 to the device 40 (step S5). The amount of power supplied is calculated by the power supply equipment 20.

The control unit 12 calculates an electricity charge based on the acquired amount of power supplied, and charges the device 40 or the user 50 of the device 40 for the power supplied (step S6). After performing step S6, the control unit 12 ends the process shown by the flowchart of FIG. 2.

As described above, in the information processing method according to the present embodiment, it is possible to charge for the power supplied to the device 40 even when the power supply equipment 20 does not have a configuration for authenticating the device 40. As a result, the information processing system 1 can implement simple, easy billing according to the amount of power supplied to the device 40.

Example of Flowchart of Power Supply Method

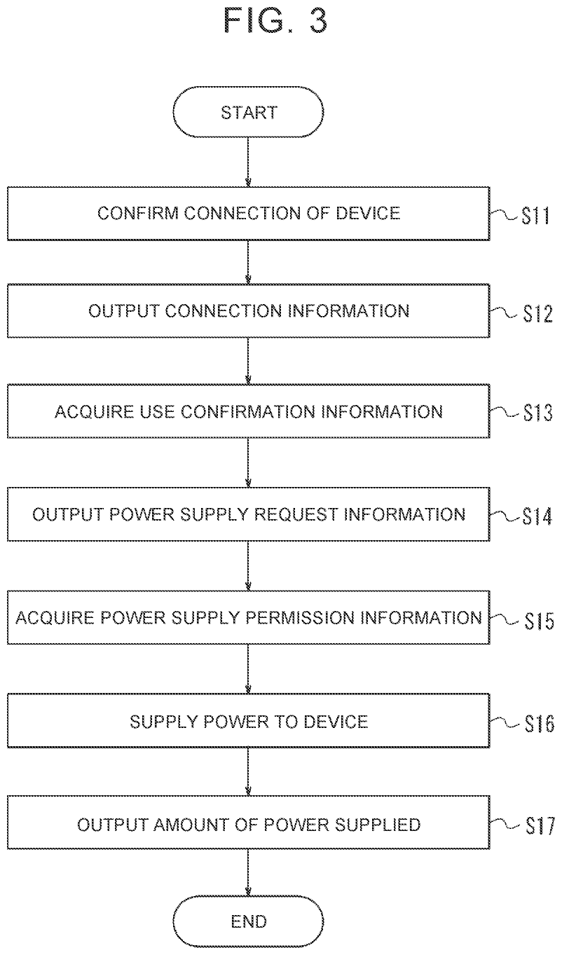

The power supply control unit 22 of the power supply equipment 20 included in the information processing system 1 may perform a power supply method including a process shown by a flowchart of FIG. 3. The power supply method may be implemented as a power supply program that is executed by a processor such as the power supply control unit 22. The power supply program may be stored in a non-transitory computer-readable medium.

The power supply control unit 22 confirms that the device 40 is connected to the power supply unit 26 (step S11).

The power supply control unit 22 outputs the connection information to the information processing device 10 (step S12).

The power supply control unit 22 acquires the use confirmation information from the information processing device 10 (step S13). The use confirmation information is generated and output by the information processing device 10. The use confirmation information may include information indicating that power supply from the power supply equipment 20 to the device 40 is for a fee.

The power supply control unit 22 outputs the power supply request information to the information processing device 10 (step S14).

The power supply control unit 22 acquires the power supply permission information from the information processing device 10 (step S15). The power supply permission information is generated and output by the information processing device 10.

The power supply control unit 22 causes the power supply unit 26 to supply power to the device 40 connected to the power supply unit 26, based on the power supply permission information (step S16).

The power supply control unit 22 calculates the amount of power supplied to the device 40 and outputs the calculation result to the information processing device 10 (step S17). Specifically, the power supply control unit 22 may calculate the amount of power supplied to the device 40 when the power supply control unit 22 completes power supply to the device 40. The power supply control unit 22 may continuously calculate the amount of power supplied to the device 40 while power is being supplied to the device 40. After performing step S17, the power supply control unit 22 ends the process shown by the flowchart of FIG. 3.

As described above, in the power supply method according to the present embodiment, power can be supplied to the device 40 for a fee even when the power supply equipment 20 does not have a configuration for authenticating the device 40. As a result, the information processing system 1 can implement simple, easy billing according to the amount of power supplied to the device 40.

### OTHER EMBODIMENTS

The information processing system 1 can be implemented in various other embodiments. Other embodiments will be described.

The control unit 12 of the information processing device 10 may output information defining an upper limit value of the amount of power that is supplied to the device 40 as the power supply permission information. The power supply control unit 22 of the power supply equipment 20 may continuously calculate the amount of power supplied to the device 40 while power is being supplied to the device 40. The power supply control unit 22 may control the power supply unit 26 so that the amount of power supplied to the device 40 does not become larger than the upper limit value defined by the power supply permission information.

When the control unit 12 acquires the power supply request information from the power supply equipment 20 within a predetermined time after the control unit 12 outputs the use confirmation information to the power supply equipment 20, the control unit 12 may generate the power supply permission information and output the power supply permission information to the power supply equipment 20. On the other hand, when the control unit 12 fails to acquire the power supply request information from the power supply equipment 20 within the predetermined time after the control unit 12 outputs the use confirmation information to the power supply equipment 20, the control unit 12 may generate information prohibiting power from being supplied to the device 40 and output this information to the power supply equipment 20. The information prohibiting power from being supplied to the device 40 is also referred to as power supply prohibition information. By limiting the time until the control unit 12 generates the power supply permission information, the processing load on the control unit 12 or the power supply control unit 22 can be reduced.

The control unit 12 may acquire, as the billing information, the balance that can be applied to the electricity charge. The control unit 12 may continuously acquire from the power supply equipment 20 the amount of power supplied to the device 40. The control unit 12 may continuously calculate the electricity charge according to the amount of electric power supplied to the device 40, and output information for stopping power supply to the device 40 to the power supply equipment 20, when the electricity charge exceeds the balance. The information that stops power supply to the device 40 is also referred to as power supply stop information. The configuration of the power supply equipment 20 can be simplified by the control unit 12 generating the power supply stop information.

The embodiments according to the present disclosure are described above based on the drawings and examples. However, the present disclosure is not limited to the above embodiments. For example, the functions etc. included in the units, the steps, etc. can be rearranged so as not to be logically inconsistent, and a plurality of units, steps, etc. may be combined into a single unit, step, etc. or each unit, step, etc. may be divided into sub-units, sub-steps, etc. Other changes may be made without departing from the scope of the present disclosure.

What is claimed is:

1. An information processing device, comprising a control unit configured to generate power supply permission information that is information permitting power to be supplied to a device electromagnetically connected to power supply equipment, and output the power supply permission information to the power supply equipment.

2. The information processing device according to claim 1, wherein the control unit is configured to acquire device information including information identifying the device from the power supply equipment and generate the power supply permission information based on the device information.

3. The information processing device according to claim 1, wherein the control unit is configured to acquire, from the power supply equipment, user information that is information about a user of the device, and generate the power supply permission information based on the user information.

4. The information processing device according to claim 1, wherein the control unit is configured to acquire power supply request information that is information requesting power supply to the device, and generate the power supply permission information based on the power supply request information.

5. The information processing device according to claim 4, wherein the control unit is configured to generate the power supply permission information when the control unit acquires the power supply request information within a predetermined time.

6. The information processing device according to claim 5, wherein the control unit is configured to generate and output power supply prohibition information that is information prohibiting power from being supplied to the device when the control unit does not acquire the power supply request information within the predetermined time.

7. The information processing device according to claim 4, wherein the control unit is configured to acquire, as the power supply request information, information that a user of the device accepts that the power supply from the power supply equipment is for a fee.

8. The information processing device according to claim 4, wherein the control unit is configured to acquire, as the power supply request information, billing information on an electricity charge according to an amount of power supplied from the power supply equipment to the device.

9. The information processing device according to claim 8, wherein the control unit is configured to acquire the amount of power supplied from the power supply equipment to the device, calculate the electricity charge based on the amount of power supplied, and bill for the electricity charge based on the billing information.

10. The information processing device according to claim 8, wherein the control unit is configured to acquire, as the billing information, a balance that is able to be applied to the electricity charge, and when the electricity charge exceeds the balance, generate and output power supply stop information that is information for stopping the power supply to the device.

11. An information processing system, comprising:
the information processing device according to claim 1; and
the power supply equipment.

12. An information processing method, comprising generating power supply permission information that is information permitting power to be supplied to a device electromagnetically connected to power supply equipment, and outputting the power supply permission information to the power supply equipment.

13. The information processing method according to claim 12, further comprising:
acquiring device information identifying the device from the power supply equipment; and
generating the power supply permission information based on the device information.

14. The information processing method according to claim 12, further comprising:
acquiring, from the power supply equipment, user information that is information about a user of the device; and
generating the power supply permission information based on the user information.

15. The information processing method according to claim 12, further comprising:
acquiring power supply request information that is information requesting power supply to the device; and
generating the power supply permission information based on the power supply request information.

16. The information processing method according to claim 15, further comprising:
generating the power supply permission information when the power supply request information is acquired within a predetermined time; and
generating and outputting power supply prohibition information that is information prohibiting power from being supplied to the device when the power supply request information is not acquired within the predetermined time.

17. The information processing method according to claim 15, further comprising acquiring, as the power supply request information, information that a user of the device accepts that the power supply from the power supply equipment is for a fee.

18. The information processing method according to claim 15, further comprising acquiring, as the power supply request information, billing information on an electricity charge according to an amount of power supplied from the power supply equipment to the device.

19. The information processing method according to claim 18, further comprising:
acquiring the amount of power supplied from the power supply equipment to the device;
calculating the electricity charge based on the amount of power supplied; and
billing for the electricity charge based on the billing information.

20. Power supply equipment, comprising:
a power supply unit configured to supply power to a device electromagnetically connected to the power supply unit; and
a power supply control unit configured to control the power supply unit based on information acquired from an information processing device, wherein the power supply control unit is configured to control the power supply unit to supply power to the device when the power supply control unit acquires, from the information processing device, power supply permission information that is information permitting power to be supplied to the device.
